(19) United States
(12) Patent Application Publication
(10) Pub. No.: US 2023/0318016 A1
(43) Pub. Date: Oct. 5, 2023

(54) PRESSING APPARATUS AND PRESSING METHOD

(71) Applicant: HONDA MOTOR CO., LTD., Tokyo (JP)

(72) Inventors: Takashi TOYOSHIMA, Saitama (JP); Kosei MIYATA, Saitama (JP)

(21) Appl. No.: 18/182,383

(22) Filed: Mar. 13, 2023

(30) Foreign Application Priority Data
Mar. 31, 2022 (JP) 2022-061340

(51) Int. Cl. H01M 10/04; H01M 10/058

(52) U.S. Cl. CPC H01M 10/0468; H01M 10/058

(57) ABSTRACT

Provided are a pressing apparatus and a pressing method capable of lowering interfacial resistance between solid electrolyte layers and electrodes with a simple configuration. A pressing apparatus presses a laminate including electrodes (a positive current collecting electrode and a negative current collecting electrode) and solid electrolyte layers, the pressing apparatus including a compression unit (a roll pressing machine) that compresses the laminate, the compression unit being configured to compress the laminate with buffer members interposed having recesses or projections on surfaces adjacent to the laminate. In an aspect, the compression unit compresses the laminate including the negative electrode (the negative current collecting electrode) containing lithium. In an aspect, the compression unit is a roll pressing machine.

This application is based on and claims the benefit of priority from Japanese Patent Application No. 2022-061340, filed on 31 Mar. 2022, the content of which is incorporated herein by reference.

### BACKGROUND OF THE INVENTION

### Field of the Invention

The present invention relates to a pressing apparatus and a pressing method.

### Related Art

In recent years, a manufacturing method has been proposed in which a positive-electrode active material layer, a negative-electrode active material layer, and a solid electrolyte layer are efficiently adhered by roll pressing in a manufacturing process of an all-solid-state battery. A technique has been proposed in which a buffer film is interposed on a contact surface of an object with a roll in order to make a pressing intensity on a sheet-like object appropriate and to make the pressing uniform in an in-plane direction, during roll pressing (for example, see PCT International Publication No. WO 2019/189332). Further, in a roll process including applying a roll protection film to an active material layer and combining and roll pressing a current collector, an active material layer, and the roll protection film, a technique has been proposed in which a roll protection film with as little recesses and projections as possible is put on the active material layer thereby preventing damage to rolls in the roll pressing process (for example, see Japanese Unexamined Patent Application, Publication No. 2019-125499). On the other hand, a technique has been proposed in which fine recesses and projections are provided on a surface of a roll of a first stage in a three-stage roll press to improve a filling density of an active material in a foamed porous metal substrate (for example, see Japanese Unexamined Patent Application, Publication No. S58-97268).
Patent Document 1: PCT International Publication No. WO2019/189332
Patent Document 2: Japanese Unexamined Patent Application, Publication No. 2019-125499
Patent Document 3: Japanese Unexamined Patent Application, Publication No. S58-97268

### SUMMARY OF THE INVENTION

In the techniques disclosed in PCT International Publication No. WO 2019/189332 and Japanese Unexamined Patent Application, Publication No. 2019-125499, it is difficult to further lower interfacial resistance between the solid electrolyte layer and the electrode. It is conceivable to apply the technique disclosed in Japanese Unexamined Patent Application, Publication No. S58-97268 to transfer recesses and projections onto the interface to lower the interfacial resistance, but it is difficult to provide fine recesses and projections on the roll surface.

The present invention has been made in view of the above-described circumstances, and an object thereof is to provide a pressing apparatus and a pressing method capable of lowering interfacial resistance between a solid electrolyte layer and an electrode with a simple configuration. A further object of the present invention is to realize a technique for manufacturing a high-performance battery capable of repeatedly performing rapid charge and discharge.

(1) The present invention provides a pressing apparatus (for example, a pressing apparatus 1 to be described below) for pressing a laminate (for example, a laminate 3 to be described below) including electrodes (for example, a positive current collecting electrode 31 and a negative current collecting electrode 33 to be described below) and solid electrolyte layers (for example, solid electrolyte layers 32 to be described below), the pressing apparatus including a compression unit (for example, a roll pressing machine 2 to be described below) that compresses the laminate, the compression unit being configured to compress the laminate with buffer members (for example, buffer members 4 to be described below) interposed, the buffer members having recesses or projections on surfaces adjacent to the laminate.

(2) In the pressing apparatus of (1) above, the compression unit compresses a laminate having a negative electrode (for example, a negative current collecting electrode 33 to be described below) containing lithium.

(3) In the pressing apparatus of (1) or (2) above, the compression unit is a roll pressing machine (for example, a roll pressing machine 2 to be described below).

(4) The present invention provides a pressing method of pressing, with a pressing apparatus (for example, a pressing apparatus 1 to be described below), a laminate (for example, a laminate 3 to be described below) including electrodes (for example, a positive current collecting electrode 31 and a negative current collecting electrode 33 to be described below) and solid electrolyte layers (for example, solid electrolyte layers 32 to be described below), the pressing method including: a laminate conveying step (for example, a laminate conveying step S1 to be described below) of conveying the laminate together with buffer members of which surfaces facing the laminate have recesses or projections; and a compressing step (for example, a compressing step S2 to be described below) of compressing the laminate to be conveyed in the laminate conveying step with the buffer members interposed.

(5) In the pressing method of (4) above, the compressing step includes compressing a laminate having a negative electrode containing lithium.

(6) In the pressing method of (4) or (5) above, the compressing step includes compressing the laminate by roll pressing.

The pressing apparatus of (1) presses the laminate including the electrodes and the solid electrolyte layers, and includes the compression unit that compresses the laminate, the compression unit being configured to compress the laminate with the buffer members interposed having the recesses or projections on the surfaces adjacent to the laminate. Therefore, when the compression unit compresses the laminate, a compressive force is made uniform in an in-plane direction, and the recesses or projections of the buffer member are uniformly transferred onto the electrode over the entire surface. The interface between the electrode, in which the recesses or projections are formed in this way, and the solid electrolyte layer, increases in contact area, and thus it is possible to manufacture a secondary battery element with good adhesion and bondability, low DCR resistance, and high charge/discharge efficiency.

In the pressing apparatus of (2), the compression unit compresses the laminate including a negative electrode containing lithium. Thus, it is possible to obtain a lithium-ion battery element with low DCR resistance and high charge/discharge efficiency.

In the pressing apparatus of (3), the compression unit is a roll pressing machine. Thus, the laminate can be compressed with high efficiency.

The pressing method of (4) is a pressing method of pressing a laminate including electrodes and solid electrolyte layers, the pressing method including the laminate conveying step of conveying the laminate with the buffer members of which surfaces facing the laminate have recesses or projections and the compressing step of compressing the laminate to be conveyed in the laminate conveying step with the buffer members interposed. Therefore, when the laminate is compressed in the compressing step, a compressive force is made uniform in an in-plane direction, and the recesses or projections of the buffer member are uniformly transferred onto the electrode over the entire surface. The interface between the electrode, in which the recesses or projections are formed in this way, and the solid electrolyte layer, increases in contact area, and thus it is possible to manufacture a secondary battery element with good adhesion and bondability, low DCR resistance, and high charge/discharge efficiency.

In the pressing method of (5), the compressing step includes compressing the laminate including the negative electrode containing lithium. Thus, it is possible to manufacture a lithium-ion battery element with low DCR resistance and high charge/discharge efficiency.

In the pressing method of (6), the compressing step includes compressing the laminate by roll pressing. Thus, the laminate can be compressed with high efficiency.

### BRIEF DESCRIPTION OF THE DRAWINGS

FIG. 1 is a schematic diagram showing a compression unit of a pressing apparatus according to an embodiment of the present invention;

FIG. 2 is a perspective view of the compression unit shown in FIG. 1;

FIG. 3 is a schematic diagram showing not only a laminate to be compressed by the compression unit shown in FIG. 1 but also buffer members;

FIG. 4 is a view showing a surface property of the buffer member shown in FIG. 3;

FIG. 5 is a view showing an interface between the electrode, which is compressed by the compression unit shown in FIG. 1, and a solid electrolyte layer;

FIG. 6 is a view for explaining superiority of an all-solid-state battery in a case where the buffer member is applied during roll pressing;

FIG. 7 is a view for explaining a comparison of effects when the buffer member is applied and not applied during roll pressing; and

FIG. 8 is a process diagram showing a pressuring method according to an embodiment of the present invention.

### DETAILED DESCRIPTION OF THE INVENTION

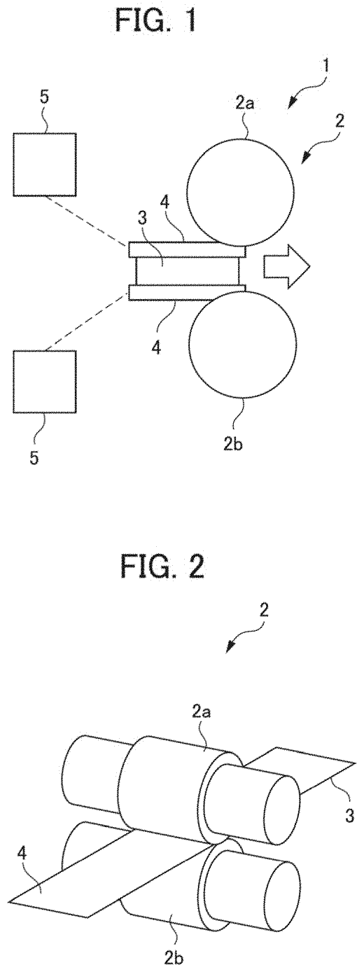

FIG. 1 is a schematic diagram showing a roll pressing machine 2 as a compression unit of a pressing apparatus 1 according to an embodiment of the present invention. The roll pressing machine 2 includes a pair of pressing rollers 2a and 2b made of metal. FIG. 2 is a perspective view of the pressing rollers 2a and 2b. The pair of pressing rollers 2a and 2b rotate in a conveying direction (in a direction of an arrow in FIG. 1) of a laminate 3 by a rotation mechanism (not shown), and compress the laminate 3 sandwiched therebetween. More specifically, the roll pressing machine 2 uses the pair of pressing rollers 2a and 2b to compress the laminate 3, which is being conveyed, with buffer members 4 interposed between the pressing rollers, the buffer member having recesses or projections on a surface facing the laminate 3. The buffer members 4 are sent out from feeders 5, and are conveyed together with the laminate 3 such that the surfaces having the recesses or the projections are placed along the laminate 3, which is being conveyed, to face the laminate 3.

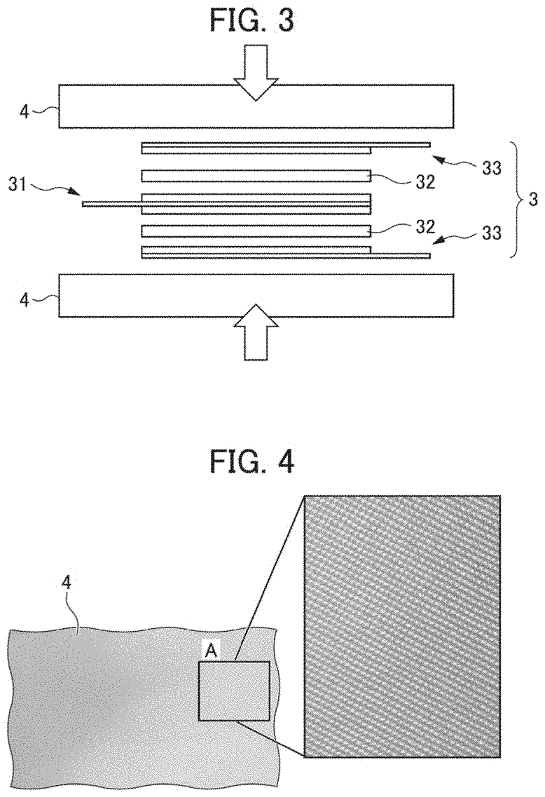

FIG. 3 is a schematic diagram showing not only the laminate 3 to be compressed by the roll pressing machine 2 but also the buffer members. The laminate 3 is configured such that negative current collecting electrodes 33 are laminated on one surface and the other surface of a positive current collecting electrode 31 through solid electrolyte layers 32, respectively. The positive current collecting electrode 31 is an electrode formed by coating a positive electrode material mixture containing a conductive auxiliary agent and a binder in a positive-electrode active material such as lithium cobalt oxide or lithium phosphate, on both surfaces of a single positive electrode sheet-like current collector which is a collector foil such as aluminum. The negative current collecting electrode 33 is an electrode formed by coating a negative electrode material mixture containing a binder in a negative-electrode active material such as graphite or lithium titanate, on a surface of a single negative electrode sheet-like current collector which is a collector foil such as copper. The buffer members 4 are arranged such that the surfaces thereof having the recesses or projections correspond to both surfaces of the laminate 3.

FIG. 4 is a plan view showing the surface of the buffer member 4 facing the laminate 3. In FIG. 4, a surface A is enlarged and a surface property thereof is shown. The facing surface has recesses or projections, but, in this example, is a rough surface in which recesses and projections are uniformly distributed in a surface direction. The buffer member 4 has a Young's modulus smaller than that of the pair of metal pressing rollers 2a and 2b of the roll pressing machine 2. Therefore, the buffer member 4 macroscopically absorbs deflection of the pressing rollers 2a and 2b during compression of the laminate 3, and uniformly compresses the laminate 3 over its entire surface. On the other hand, microscopically, the buffer member 4 transfers the recesses and projections of the rough surface to the negative current collecting electrode 33 of the laminate 3.

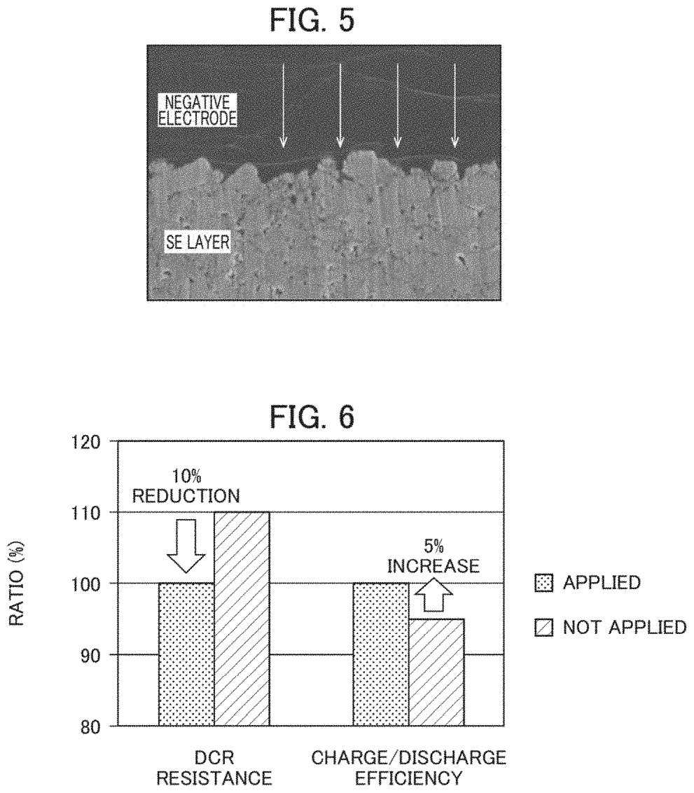

FIG. 5 is a view showing an interface between the negative current collecting electrode 33, to which the recesses and projections on the rough surface of the buffer member 4 are transferred, and the solid electrolyte layer 32. In FIG. 5, the negative current collecting electrode 33 is indicated as a “negative electrode”, and the solid electrolyte layer 32 is indicated as an “SE layer”. Portions indicated by long arrows have relatively fine recesses and projections, and have a contact area between the “negative electrode” and the “SE layer” per unit area that is large when viewed in a direction of the arrows. In other words, a DCR resistance becomes low at the interface between the negative current collecting electrode 33 and the solid electrolyte layer 32. Therefore, the negative current collecting electrode 33 and the solid electrolyte layer 32 can be evaluated as elements of a secondary battery (all-solid-state battery) with high charge/discharge efficiency.

FIG. 6 is a view for explaining superiority of the all-solid-state battery in a case where the buffer member 4 is applied during roll pressing. In FIG. 6, the case where the buffer member 4 is applied during roll pressing is indicated as “applied”, and the case where the buffer member 4 is not applied during roll pressing is indicated as “not applied”. As can be easily read from FIG. 6, both of the DCR resistance and the charge/discharge efficiency are superior when the buffer member 4 is applied during roll pressing.

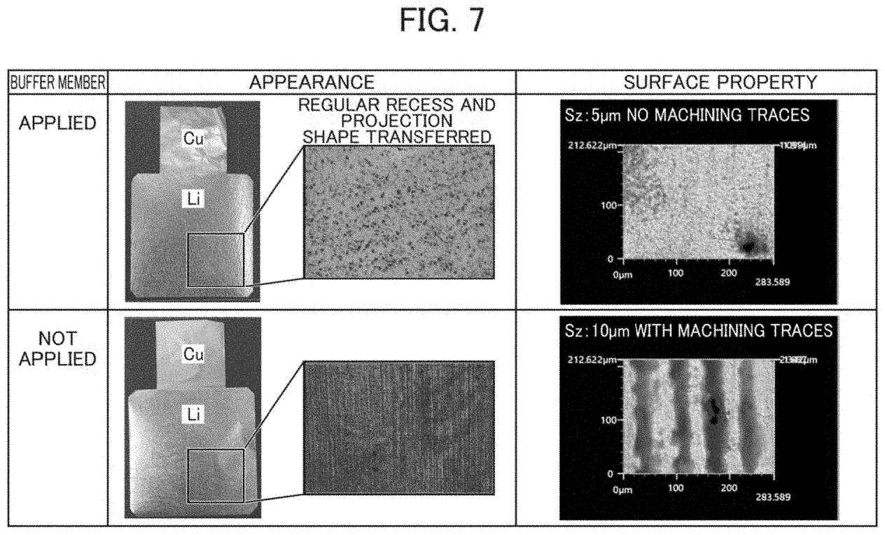

FIG. 7 is a view for explaining a comparison of effects when the buffer member 4 is applied and not applied during roll pressing with the roll pressing machine 2. In FIG. 7, regarding the negative current collecting electrode 33, a copper collector foil is indicated as “Cu”, and a negative-electrode active material such as lithium titanate is indicated as “Li”. When the buffer member 4 is applied during roll pressing, the recesses and projections on the rough surface of the buffer member 4 were transferred to the negative-electrode active material of the negative current collecting electrode 33, but no machining traces were observed. On the other hand, when the buffer member 4 is not applied during roll pressing, naturally, the recesses and projections were not transferred, and machining traces were observed.

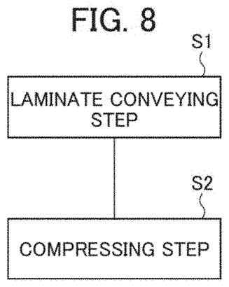

FIG. 8 is a process diagram showing a pressing method according to an embodiment of the present invention. The pressing method with the pressing apparatus 1 includes two steps as follows. In other words, the pressing method includes a laminate conveying step S1 of conveying the laminate 3 together with the buffer members 4 of which surfaces facing the laminate 3 have recesses or projections, and a compressing step S2 of compressing the laminate 3 to be conveyed in the laminate conveying step S1 with the buffer members 4 interposed.

According to the pressing apparatus and the pressing method of the present embodiment, the following effects are achieved.

The pressing apparatus 1 of (1) presses the laminate 3 including the positive current collecting electrode 31, the negative current collecting electrodes 33, and the solid electrolyte layers 32, the pressing apparatus 1 including the roll pressing machine 2 as the compression unit that compresses the laminate 3, and the roll pressing machine 2 compresses the laminate 3 with the buffer members 4 interposed having the recesses or projections on the surfaces adjacent to the laminate 3. Therefore, when the roll pressing machine 2 compresses the laminate 3, a compressive force is made uniform in an in-plane direction, and the recesses or projections of the buffer member 4 are uniformly transferred onto the negative current collecting electrode 33 over the entire surface. The interface between the negative current collecting electrode 33, in which the recesses or projections are formed in this way, and the solid electrolyte layer 32, increases in contact area, and thus it is possible to manufacture a secondary battery element with good adhesion and bondability, low DCR resistance, and high charge/discharge efficiency.

The pressing apparatus 1 of (2) compresses the negative current collecting electrode 33 formed by coating the negative electrode material mixture containing a binder in a negative-electrode active material such as graphite or lithium titanate, on a surface of a single negative electrode sheet-like current collector which is a collector foil such as copper. Thus, the interface between the negative current collecting electrode 33 and the solid electrolyte layer 32, increases in contact area, and thus it is possible to obtain a secondary battery element with good adhesion and bondability, low DCR resistance, and high charge/discharge efficiency.

In the pressing apparatus of (3), the compression unit is the roll pressing machine 2. Thus, the laminate can be compressed with high efficiency.

The pressing method of (4) presses the laminate 3 including the positive current collecting electrode 31, the negative current collecting electrodes 33, and the solid electrolyte layers 32, the pressing method including the laminate conveying step S1 of conveying the laminate 3 with the buffer members 4 of which surfaces facing the laminate 3 have recesses or projections and the compressing step S2 of compressing the laminate 3 to be conveyed in the laminate conveying step S1 with the buffer members 4 interposed. Therefore, when the laminate 3 is compressed in the compressing step S2, a compressive force is made uniform in an in-plane direction, and the recesses or projections of the buffer member 4 are uniformly transferred onto the electrode over the entire surface. The interface between the negative current collecting electrode 33, in which the recesses or projections are formed in this way, and the solid electrolyte layer 32, increases in contact area, and thus it is possible to manufacture a secondary battery element (all-solid-state battery) with good adhesion and bondability, low DCR resistance, and high charge/discharge efficiency.

In the pressing method of (5), the compressing step S2 includes compressing the laminate including the negative electrode containing lithium. Thus, it is possible to manufacture a lithium-ion battery element with low DCR resistance and high charge/discharge efficiency.

In the pressing method of (6), the compressing step S2 includes compressing the laminate 3 by roll pressing. Thus, the laminate 3 can be compressed with high efficiency.

Although an embodiment of the present invention has been described above, the present invention is not limited thereto. Appropriate changes may be made within the scope of the present invention. For example, the laminate may be compressed by plate pressing instead of the roll pressing.

### EXPLANATION OF REFERENCE NUMERALS

1 . . . pressing apparatus
2 . . . roll pressing machine
2a, 2b . . . pressing roller
3 . . . laminate
4 . . . buffer member
5 . . . feeder
31 . . . positive current collecting electrode
32 . . . solid electrolyte layer
33 . . . negative current collecting electrode
S1 . . . laminate conveying step
S2 . . . compressing step

What is claimed is:

1. A pressing apparatus for pressing a laminate including electrodes and solid electrolyte layers, the pressing apparatus comprising:
a compression unit that compresses the laminate, the compression unit being configured to compress the laminate with buffer members interposed, the buffer members having recesses or projections on surfaces adjacent to the laminate.

2. The pressing apparatus according to claim 1, wherein the compression unit compresses a laminate having a negative electrode containing lithium.

3. The pressing apparatus according to claim 1, wherein the compression unit is a roll pressing machine.

4. A pressing method for pressing a laminate comprising electrodes and solid electrolyte layers with a pressing apparatus, the pressing method comprising:
a laminate conveying step of conveying the laminate together with buffer members of which surfaces facing the laminate have recesses or projections; and
a compressing step of compressing the laminate to be conveyed in the laminate conveying step with the buffer members interposed.

5. The pressing method according to claim 4, wherein the compressing step includes compressing a laminate having a negative electrode containing lithium.

6. The pressing method according to claim 4, wherein the compressing step includes compressing the laminate by roll pressing.
